(19) United States
(12) Patent Application Publication
(10) Pub. No.: US 2012/0087161 A1
(43) Pub. Date: Apr. 12, 2012

(54) POWER SUPPLY CONNECTED IN PARALLEL WITH A POWER SWITCH FOR THE CONTROL CIRCUIT THEREOF

(75) Inventor: Nils Stahlhut, Roettenbach (DE)

(73) Assignee: SIEMENS AKTIENGESELLSCHAFT, MUENCHEN (DE)

(21) Appl. No.: 13/378,755

(22) PCT Filed: Jun. 16, 2009
(86) PCT No.: PCT/EP2009/004616

§ 371 Date: Dec. 16, 2011

(51) Int. Cl. H02H 7/125; H02M 7/155; H02M 7/06

(52) U.S. Cl. 363/54; 363/126

(57) ABSTRACT

A power converter circuit for generating a supply voltage for a power semiconductor switch. A series circuit formed of a diode unit having diodes connected in reverse and a protection circuit is connected in parallel with the power semiconductor switch. The diode voltage generates a feed voltage that is transformed, rectified, and provided as a supply voltage.

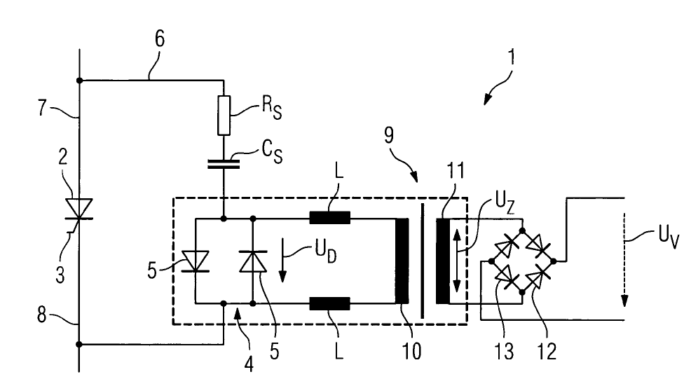

The invention relates to a power converter circuit for generating a supply voltage comprising a power semiconductor switch, voltage generating means connected in parallel with the power semiconductor switch, which are designed for generating a feed voltage, transformation means, which are connected to the voltage generating means and are designed for converting the feed voltage into an intermediate AC voltage, and a rectifier unit for rectifying the intermediate AC voltage to obtain the supply voltage.

The invention furthermore relates to a converter comprising a bridge circuit of power converter valves, the power converter valves having a series circuit composed of such power converter circuits.

Such a power converter circuit and such a converter are already known from DE 100 45 093 A1. The power converter circuit described therein has a gate turn-off thyristor (GTO) as power semiconductor switch. A so-called snubber, as it is known to the person skilled in the art, is arranged in a bridging branch in parallel with the turn-off power semiconductor. The snubber substantially consists of a limiting resistor and a protective capacitor which are connected in series. The snubber serves to avoid an excessively rapid voltage rise upon the power semiconductor switch being turned off and an excessively high voltage drop across the power semiconductor switch. In this case, the power semiconductor switch is part of a power converter in the field of power transmission and is at a high-voltage potential during the operation. A so-called drive unit serves for generating electrical control signals for the power semiconductor switch, said drive unit generally being connected to a regulating unit via an electrically non-conductive optical waveguide, said regulating unit being at a potential close to the ground potential. The regulating unit provides, on the output side, optical triggering signals that are transmitted via the optical waveguide to the drive unit, which is at a high-voltage potential. Proceeding from the optical control signals, the drive unit generates electrical control signals for the power semiconductor switch, which in this way is switched back and forth between a high-impedance, that is to say non-conducting, state and a low-impedance, conducting state.

For the power supply of the drive unit, a DC voltage dropped across the protective capacitor is tapped off and led to a switch-mode power supply, the switch-mode power supply having a transistor for chopping the DC voltage to generate a rectangular voltage. The rectangular voltage thus obtained is led to a transformer as transformation means, which transformer transforms the rectangular voltage into the desired intermediate AC voltage. A rectifier is connected downstream of the transformer, said rectifier providing from the intermediate AC voltage provided by the transformer on the output side the necessary supply voltage for the drive unit of the power semiconductor switch.

EP 0 868 014 B1 likewise discloses a power converter circuit which enables a supply voltage to be generated for a drive unit of a power semiconductor switch. In this case, the power semiconductor switch is a so-called IGBT, with which a freewheeling diode is connected in parallel in an opposite sense. A current limiting resistor and a protective capacitor are again arranged in a parallel branch with respect to the IGBT and with respect to the freewheeling diode. With the aid of a voltage divider, part of the voltage dropped across the protective capacitor is tapped off and used for charging a voltage generating means, which is realized there as a capacitor, to a DC voltage of approximately 300 V. The voltage dropped across said capacitor is regulated in a complicated manner by means of a regulation of the current flow in a bypass branch running in parallel with the capacitor. Furthermore, damping means are provided. Finally, transformation means in the form of a step-down or step-up converter are disclosed, which on the input side are connected to the regulated capacitor and on the output side provide the desired supply voltage as DC voltage.

It is an object of the invention to provide a power converter circuit of the type mentioned in the introduction which is robust and has a simple and cost-effective construction.

The invention achieves this object by virtue of the fact that the voltage generating means are realized as a diode unit having diodes connected in parallel with one another in opposite senses, the diode unit being arranged in a manner connected in parallel with the power semiconductor switch.

According to the invention, two diodes connected in parallel with one another in opposite senses serve for generating an output AC voltage. The diodes connected in parallel in opposite senses form a diode unit, through which a current flows in both directions during the switching of the power semiconductor arranged in parallel with the diode unit. On account of said current, an alternating forward voltage U_{D} is dropped across the diodes of the diode unit. Said forward voltage is virtually constant with regard to its amplitude over a large range of the current intensity. Consequently, the diode unit converts the snubber current into an AC voltage of constant magnitude, which is designated here as feed voltage. The feed voltage is subsequently transformed to the desired voltage level and the transformed intermediate AC voltage is rectified, such that the desired rectified supply voltage is available. According to the invention, therefore, fault-susceptible switching or regulating elements are avoided. A simple and robust construction is provided which manages without additional snubber elements, as are present in the power converter circuits in accordance with the prior art. Moreover, no damping circuit is required in the context of the invention. Furthermore, both polarities of the snubber current can be utilized. The transformation means provide potential isolation, which can be advantageous depending on the application. Furthermore, the diodes, which require no driving whatsoever, can be spatially separated from the remaining components of the power converter circuit. They are advantageously thermally conductively connected to a cooling system of the power semiconductor such that the heat arising during the generation of the feed voltage can be reliably dissipated.

Advantageously, a parallel branch in which a current limiting resistor, a protective capacitor and the diode unit are arranged in series is connected in parallel with the power semiconductor switch. In this case, the current limiting resistor and the protective capacitor form a so-called snubber. It is thus ensured that the entire snubber current flows through the diode unit.

Expediently, the diode unit is connected to the cathode of the power semiconductor switch directly and is connected to the anode of the power semiconductor switch via the protective capacitor and the limiting resistor.

Expediently, the transformation means are a transformer, a first winding of the transformer being connected to the diode unit and the second winding of the transformer being connected to the rectifier unit. As has already been explained further above, the transformer provides potential isolation between the rectifier unit and the diode unit, such that the components disposed downstream of the rectifier unit are independent of the potential of the snubber and of the diode unit. Consequently, negative voltages can also be generated on the output side of the transformer.

Filter means are advantageously provided. Said filter means are expediently arranged between the diode unit and the transformation means and serve for smoothing the AC voltage as feed voltage which is generated by the diode unit.

Expediently, the power semiconductor switch is a thyristor.

In a departure therefrom, the power semiconductor switch is a turn-off power semiconductor with a freewheeling diode connected in parallel therewith in the opposite sense.

Further advantages of the invention are the subject of the following description of exemplary embodiments of the invention with reference to the figures of the drawing, wherein the FIGURE shows an exemplary embodiment of the power converter circuit according to the invention.

The FIGURE shows a circuit diagram of an exemplary embodiment of the power converter circuit 1 according to the invention. The power converter circuit 1 comprises a power semiconductor switch which is embodied as a thyristor 2 and which, with the aid of an electrical control signal at its gate terminal 3, can be converted from a non-conducting state, that is to say a high-impedance conduction state, into a conducting state, that is to say a low-impedance conduction state. In this case, the thyristor 2 is connected in series with a multiplicity of thyristors (not illustrated in the FIGURE) which have a power converter circuit identical to the power converter circuit 1 shown in the FIGURE. This series circuit of thyristors forms a power converter valve which is used in power distribution and transmission, for example for high-voltage direct-current transmission, for power factor correction or the like. In this case, the power converter valves form a bridge circuit, designated as a converter. The converter also comprises a protective and regulating unit, which is at a potential close to the ground potential.

In order to generate the triggering or control signals at the gate terminal 3 of the thyristor 2, a drive unit (not illustrated in the FIGURE) is provided, which is connected to the regulating unit via an optical waveguide. The regulating unit generates a sequence of optical control signals, which are converted into electrical control signals at the gate terminal 3 by the respective drive unit. The power required for this purpose is provided by the power converter circuit 1, which provides a supply voltage Uᵥ on the output side.

A diode unit 4 consisting of two diodes 5 connected in parallel with one another in opposite senses serves for the original voltage generation. The diode unit 4 is arranged in a parallel branch 6 with respect to the thyristor 2, said parallel branch connecting an anode terminal 7 of the thyristor 2 to the cathode terminal 8 of the thyristor 2. A snubber is arranged in the parallel branch 6, said snubber consisting of a current limiting resistor Rₛ and a protective capacitor Cₛ which are arranged in series with one another. The snubber serves to protect the thyristor 2 in particular against rapid voltage rises and against high current loads.

The diode unit 4 is likewise arranged in the parallel branch 6 in a manner connected in series with the limiting resistor Rₛ and the protective capacitor C. On account of the switching of the thyristor 2 between a high-impedance and a low-impedance state, a current flow via the parallel branch 6 occurs and a current flow through the diode unit 4 thus occurs. This current flow can be effected in both directions on account of the diodes 5 being arranged in parallel in opposite senses. On account of this snubber current an alternating forward voltage U_{D} is dropped across the diodes 5, the amplitude of said voltage being virtually constant over a wide range of current intensities. The forward voltage U_{D} is designated hereinafter as feed voltage U_{D}.

A transformer 9 is connected in parallel with the diode unit 4. In other words, a primary winding 10 of the transformer is connected to the output terminals of the diode unit 4. The feed voltage U_{D} is an AC voltage, with the result that, at a secondary winding 11 of the transformer, it is possible to generate an intermediate voltage U_{z} having an amplitude that is expediently high for the components respectively connected downstream. Finally, the alternating intermediate AC voltage U_{z} provided by the secondary winding 11 is applied to the input of a rectifier 12, which in other words is connected to the secondary winding 11 of the transformer 9. The rectifier 12, consisting of diodes 13, for example, provides the desired supply voltage Uᵥ as DC voltage on the output side.

Filter means L are connected between the diode unit 4 and the transformer 9, said filter means being embodied for example as a customary low-pass filter.

1-9. (canceled)

10. A power converter circuit for generating a supply voltage, comprising:
a power semiconductor switch;
a voltage generator configured for generating a feed voltage, said voltage generator being a diode unit connected in parallel with said power semiconductor switch and said diode unit having diodes connected in parallel with one another in opposite senses;
a transformer device connected to said voltage generator and configured for transforming the feed voltage to an intermediate AC voltage; and
a rectifier unit for rectifying the intermediate AC voltage to obtain the supply voltage.

11. The power converter circuit according to claim 10, which comprises a parallel branch connected in parallel with said power semiconductor switch, said parallel branch including a current limiting resistor, a protective capacitor, and said diode unit connected in series with one another.

12. The power converter circuit according to claim 11, wherein said diode unit is directly connected to a cathode of said power semiconductor switch and indirectly connected to an anode of said power semiconductor switch via said protective capacitor and said limiting resistor.

13. The power converter circuit according to claim 10, wherein said transformation means are a transformer, a first winding of the transformer being connected to the diode unit and the second winding of the transformer being connected to the rectifier unit.

14. The power converter circuit according to claim 13, which further comprises filter means.

15. The power converter circuit according to claim 14, wherein said filter means are connected between said diode unit and said transformer device.

16. The power converter circuit according to claim 10, wherein said power semiconductor switch is a thyristor.

17. The power converter circuit according to claim 10, wherein said power semiconductor switch is a turn-off power semiconductor with a freewheeling diode connected in parallel therewith in a opposite sense.

18. A converter, comprising a bridge circuit of power converter valves, said power converter valves having a series circuit composed of power converter circuits according to claim 10.
